(19) United States
(12) Patent Application Publication
(10) Pub. No.: US 2025/0014199 A1
(43) Pub. Date: Jan. 9, 2025

(54) METHOD AND APPARATUS WITH TARGET DISTANCE ESTIMATION

(71) Applicant: SAMSUNG ELECTRONICS CO., LTD., Suwon-si (KR)

(72) Inventors: Woo Jung PARK, Suwon-si (KR); Jinhyuk CHOI, Suwon-si (KR)

(73) Assignee: SAMSUNG ELECTRONICS CO., LTD., Suwon-si (KR)

(21) Appl. No.: 18/527,749

(22) Filed: Dec. 4, 2023

(30) Foreign Application Priority Data
Jul. 7, 2023 (KR) 10-2023-0088376

(51) Int. Cl. G06T 7/55; G06T 7/60

(52) U.S. Cl. CPC G06T 7/55; G06T 7/60; G06T 2207/30252

(57) ABSTRACT

A processor-implemented method includes: determining a first length of a captured object included in an image frame captured by a single camera; determining a second length of a real object corresponding to the captured object; and estimating a target distance between an apparatus and the real object based on a ratio between the first length and the second length.

### CROSS-REFERENCE TO RELATED APPLICATIONS

This application claims the benefit under 35 USC § 119 (a) of Korean Patent Application No. 10-2023-0088376 filed on Jul. 7, 2023, in the Korean Intellectual Property Office, the entire disclosure of which is incorporated herein by reference for all purposes.

### BACKGROUND

### 1. Field

The following description relates to a method and apparatus with target distance estimation.

### 2. Description of Related Art

Autonomous driving technology may include various technologies for supporting driving. For example, a lane departure warning system (LDWS) may determine whether a vehicle (e.g., an ego vehicle) departs from a driving lane for driving assistance, and an adaptive cruise control (ACC) system may automatically control the velocity of a vehicle such that the vehicle maintains a certain distance from a vehicle ahead. In addition, an advanced driver assistance system (ADAS) and/or an autonomous driving (AD) system including the technologies described above may control a vehicle to recognize and/or determine a situation during driving using a detection sensor, an image processing device, a communication device, or the like to control operations of the vehicle or inform a driver of this.

For example, performing autonomous driving of level 2 by the ADAS may require recognition of a situation on a nearby road and determination of an intention, and when the level of autonomous driving is increased to level 3 or level 4, a higher accuracy of the position of an ego vehicle in longitudinal (or driving) and/or lateral directions may be required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: determining a first length of a captured object included in an image frame captured by a single camera; determining a second length of a real object corresponding to the captured object; and estimating a target distance between an apparatus and the real object based on a ratio between the first length and the second length.

The captured object may be a captured fixed object, the real object may be a real fixed object, and the apparatus may be a vehicle.

The determining of the second length may include: determining a size of the real fixed object from among standardized sizes of the real fixed object; and determining the second length using the determined size.

The determining of the size of the real fixed object may include determining either one or both of a length and a width corresponding to the captured fixed object.

The determining of the size of the real fixed object may include determining the size of the real fixed object based on speed information of the vehicle.

The image frame may include a first image frame and a second image frame each including the captured fixed object, and the determining of the size of the real fixed object may include: determining a moving distance variation of the vehicle between the first image frame and the second image frame based on speed information of the vehicle; determining distance variations between a first fixed object included in the first image frame and a second fixed object included in the second image frame, based on each of standardized sizes of the real fixed object; and determining the size of the real fixed object based on a result of comparing the moving distance variation of the vehicle and the distance variations.

The standardized sizes of the real fixed object may include a first size and a second size different from the first size, and the determining of the distance variations may include: determining a first distance variation between the first fixed object and the second fixed object based on the first size; and determining a second distance variation between the first fixed object and the second fixed object based on the second size.

The determining of the size of the real fixed object may include: determining a first difference between the moving distance variation of the vehicle and the first distance variation; determining a second difference between the moving distance variation of the vehicle and the second distance variation; and determining the size of the real fixed object based on a result of comparing the first difference and the second difference.

The determining of the size of the real fixed object based on the result of comparing the first difference and the second difference may include: in response to the first difference being less than the second difference, determining the first size as the size of the real fixed object; and in response to the first difference being greater than or equal to the second difference, determining the second size as the size of the real fixed object.

The determining of the first length may include determining the first length based on a bounding box for detecting the captured fixed object.

The captured fixed object may include a road sign, and the road sign may include any one or any combination of any two or more of a speed sign, a distance sign, and a milestone.

The method may include correcting the target distance using speed information of the vehicle and a Kalman filter.

The single camera may include a pinhole camera.

The method may include correcting a position of the vehicle by mapping the target distance to map information.

In one or more general aspects, a non-transitory computer-readable storage medium stores instructions that, when executed by a processor, configure the processor to perform any one, any combination, or all of operations and/or methods described herein.

In one or more general aspects, an apparatus includes: one or more processors configured to: determine a first length of a captured object included in an image frame captured by a single camera; determine a second length of a real object corresponding to the captured object; and estimate a target distance between an apparatus and the real object based on a ratio between the first length and the second length.

The captured object may be a captured fixed object, the real object may be a real fixed object, and the apparatus may be a vehicle.

For the determining of the second length, the one or more processors may be configured to: determine a size of the real fixed object from among standardized sizes of the real fixed object; and determine the second length using the determined size.

The image frame may include a first image frame and a second image frame each including the captured fixed object, and, for the determining of the size of the real fixed object, the one or more processors may be configured to: determine a moving distance variation of the vehicle between the first image frame and the second image frame based on speed information of the vehicle; determine distance variations between a first fixed object included in the first image frame and a second fixed object included in the second image frame based on each of the standardized sizes of the real fixed object; and determine the size of the real fixed object based on a result of comparing the moving distance variation of the vehicle and the distance variations.

The standardized sizes of the real fixed object may include a first size and a second size different from the first size, and, for the determining of the distance variations, the one or more processors may be configured to: determine a first distance variation between the first fixed object and the second fixed object based on the first size; and determine a second distance variation between the first fixed object and the second fixed object based on the second size.

For the determining of the size of the real fixed object, the one or more processors may be configured to: determine a first difference between the moving distance variation of the vehicle and the first distance variation; determine a second difference between the moving distance variation of the vehicle and the second distance variation; and determine the size of the real fixed object based on a result of comparing the first difference and the second difference.

In one or more general aspects, a vehicle includes: a single camera configured to capture an image frame including a fixed object; and one or more processors configured to: determine a first length of the fixed object included in the image frame; determine a second length of a real fixed object corresponding to the fixed object; estimate a target distance between the vehicle and the real fixed object based on a ratio between the first length and the second length; and correct a position of the vehicle by mapping the target distance to map information.

Other features and aspects will be apparent from the following detailed description, the drawings, and the claims.

### BRIEF DESCRIPTION OF THE DRAWINGS

FIG. 1 illustrates an example situation in which a method of estimating a target distance is performed according to one or more example embodiments.

FIG. 2 illustrates an example method of estimating a target distance according to one or more example embodiments.

FIG. 3A illustrates an example method of estimating a target distance based on a height corresponding to a captured fixed object according to one or more example embodiments.

FIG. 3B illustrates an example method of estimating a target distance based on a width corresponding to a captured fixed object according to one or more example embodiments.

FIG. 4 illustrates an example method of calculating a second length according to one or more example embodiments.

FIG. 5 illustrates an example method of determining a size of a real fixed object according to one or more example embodiments.

FIG. 6 illustrates an example method of estimating a target distance based on a moving distance variation of a vehicle between image frames and a distance variation between fixed objects included respectively in the image frames according to one or more example embodiments.

FIG. 7 illustrates an example method of estimating a target distance according to one or more example embodiments.

FIG. 8 illustrates examples of fixed objects according to one or more example embodiments.

FIG. 9 illustrates an example apparatus for estimating a target distance according to one or more example embodiments.

FIG. 10 illustrates an example vehicle according to one or more example embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Example embodiments to be described below may be provided to generate visual information for assisting an augmented reality (AR) navigation system of smart vehicles or the like in steering autonomous vehicles. In addition, the example embodiments may be provided to assist intelligent systems such as head-up displays (HUD) installed for driving assistance or fully autonomous driving in vehicles in analyzing visual information and contributing to safe and comfortable driving. The example embodiments may be applied to, for example, autonomous vehicles, intelligent vehicles, smartphones, mobile devices, and/or the like.

Hereinafter, examples will be described in detail with reference to the accompanying drawings. When describing the examples with reference to the accompanying drawings, like reference numerals refer to like components and a repeated description related thereto is omitted.

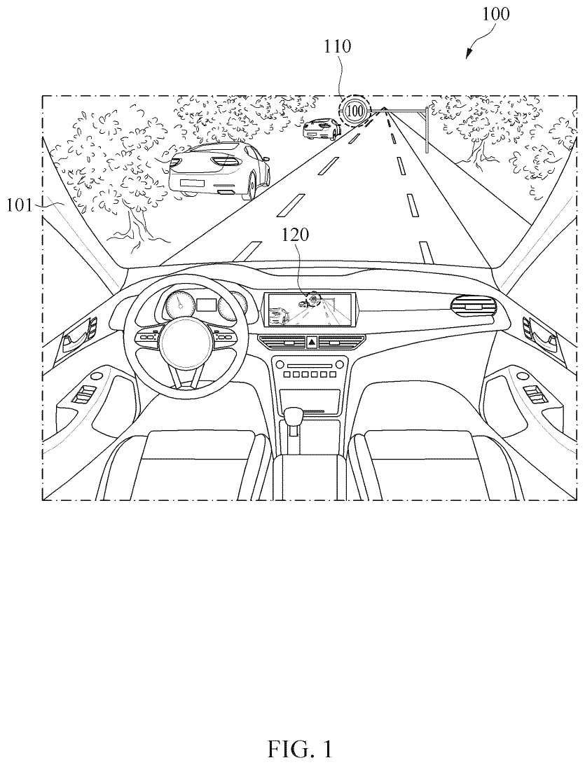

FIG. 1 illustrates an example situation in which a method of estimating a target distance is performed according to one or more example embodiments. Referring to FIG. 1, diagram 100 illustrates a situation in which, while a vehicle 101 according to an example embodiment is traveling, a single camera provided in the vehicle 101 recognizes a real fixed object (e.g., a speed sign) 110 outside the vehicle 101 and captures an image of the real fixed object 110, and an image frame including a captured fixed object 120, representing the real fixed object 110, is displayed through a navigation system inside the vehicle 101.

The term “real fixed object (e.g., the real fixed object 110)” used herein may correspond to an object fixed at a certain position without a movement, such as, for example, a road sign. The real fixed object 110 may have standardized sizes. The road sign may include, as non-limiting examples, at least one of a speed sign, a distance sign, or a milestone. In another non-limiting example, the object 110 may instead be a moving object (e.g., an object moving with respect to the vehicle and captured by the single camera while the object moving is moving with respect to the vehicle).

The vehicle 101 may estimate a target distance from the vehicle 101 to the real fixed object 110 through a process to be described below to correct a position in a longitudinal direction (or driving direction) and/or lateral direction of the vehicle 101.

The vehicle 101 may be an intelligent or smart vehicle in which an advanced driver assistance system (ADAS) and/or autonomous or automatic driving (AD) system configured to recognize and/or determine situations during driving using, for example, sensors, an image processing device, a communication device, and the like and control operations of the vehicle 101 and/or inform a driver of this is provided. The ADAS and/or the AD system may recognize fixed objects on a driving road, road marks including lanes, and/or road signs, based on a vehicle driving image captured by a camera.

The vehicle 101 may map the target distance estimated based on the image frame obtained by the ADAS from the camera to previously constructed map information to correct the position of the vehicle 101 and correct lanes on a driving road recognized by the vehicle 101 and driving information related thereto. The vehicle 101 may also receive various driving information including the lanes recognized in relation to the driving road through the navigation system.

Hereinafter, the term “vehicle” (e.g., the vehicle 101) used herein may indicate all types of means of transportation with a driving engine used to transport people or objects, such as, for example, cars, buses, motorcycles, and/or trucks. The “vehicle” (e.g., the vehicle 101) may also be referred to herein as an “ego vehicle.”

In addition, the term “road” used herein may indicate various types of roads on which a plurality of vehicles including the vehicle 101 travel, such as, for example, highways, national highways, local roads, express national highways, and/or cars-only roads. A road may include one or more lanes. The term “driving road” used herein may be construed as a road on which a vehicle (e.g., the vehicle 101) is currently traveling.

In addition, the term “lane” may indicate a road space divided by lines marked on the surface of a road. The term “driving lane” may be construed as a lane along which a vehicle (e.g., the vehicle 101) is currently traveling among a plurality of lanes, that is, a lane space currently occupied and used by the vehicle (e.g., the vehicle 101). The driving lane may also be referred to herein as an “ego lane.” One lane may be divided by lines marked on the left and right sides of the lane.

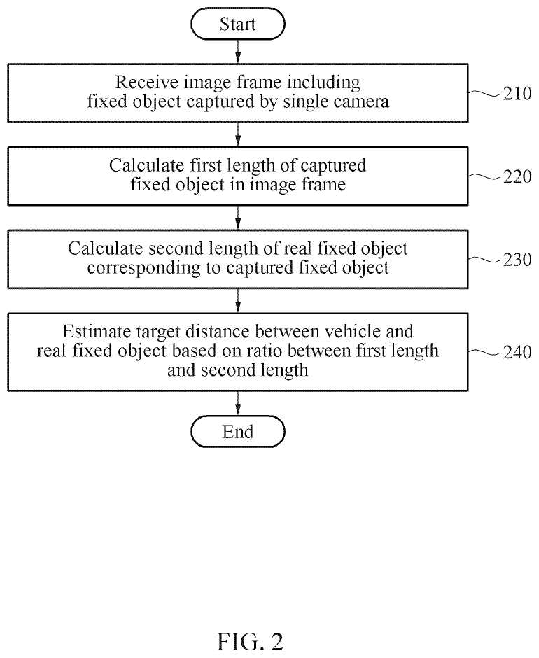

FIG. 2 illustrates an example method of estimating a target distance according to one or more example embodiments. Operations to be described hereinafter may be performed in sequential order, but may not be necessarily performed in sequential order. For example, the order of the operations may be changed and at least two of the operations may be performed in parallel.

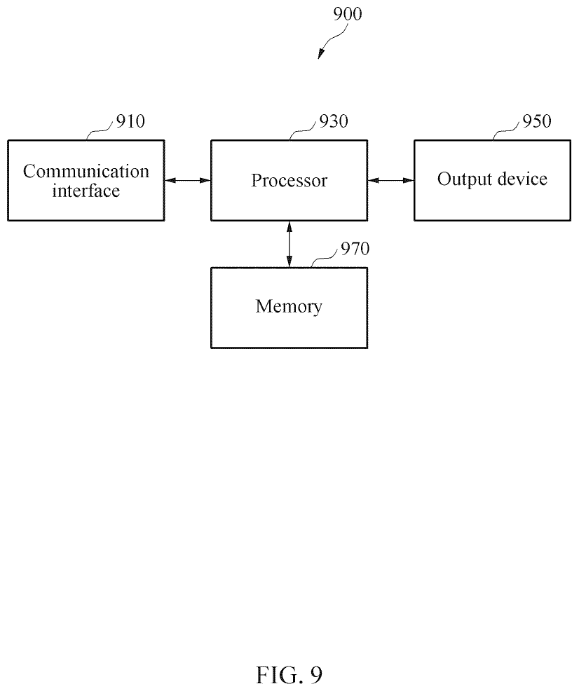

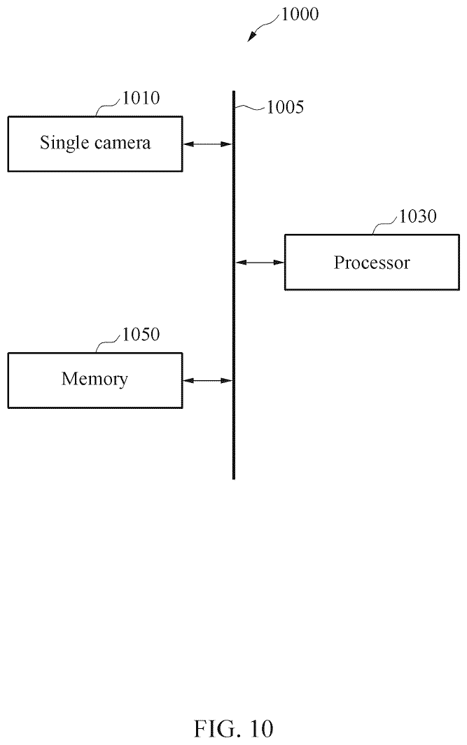

Referring to FIG. 2, an apparatus for estimating a target distance (hereinafter shortly referred to as an “estimation apparatus”) according to an example embodiment may estimate a target distance between a vehicle (e.g., an ego vehicle) and a real fixed object through operations 210 to 240 described below. The estimation apparatus may be, for example, the vehicle 101, an estimation apparatus 900 of FIG. 9, and/or a vehicle 1000 of FIG. 10 but is not necessarily limited thereto.

In operation 210, the estimation apparatus may receive an image frame including a fixed object of which an image is captured by a single camera. The fixed object whose image is captured by the single camera may be referred to herein as a captured fixed object. The single camera may be provided in the vehicle or may be a separate device. The single camera may include, for example, a pinhole camera, but is not necessarily limited thereto.

For example, as illustrated in FIG. 1, the image frame may be an image frame of a driving-related image (or herein a driving image) including a vehicle, a lane, a curb, a sidewalk, a surrounding environment, and/or a fixed object. The estimation apparatus may obtain a single image frame or a plurality of image frames using an image-capturing device (e.g., the single camera) mounted on the front of the vehicle. In this case, it may be assumed that calibration information of the image-capturing device is known in advance. The image-capturing device may include, as non-limiting examples, a mono camera, a vision sensor, an image sensor, and/or a device performing similar functions. Alternatively, the image frame may be an image captured by the image-capturing device included in the estimation apparatus or another device other than the estimation apparatus.

In operation 220, the estimation apparatus may calculate (e.g., determine) a first length of the captured fixed object included in the image frame received in operation 210. The estimation apparatus may calculate the first length based on a bounding box for detecting the captured fixed object. For example, the estimation apparatus may extract feature information of the captured fixed object from the image frame, using, for example, a convolutional neural network (CNN), a deep neural network (DNN), a support vector machine (SVM), and/or the like, that is trained in advance to recognize various types of fixed objects. The CNN may be a region-based CNN that is trained in advance with feature information of fixed objects. For example, the CNN may be trained to determine both a bounding box of a (captured) fixed object to be detected in an image frame and a type of the (captured) fixed object to be detected. In addition, the estimation apparatus may extract the feature information of the captured fixed object using various machine learning methods. The estimation apparatus may calculate a probability value for each type (e.g., class) of the feature information of the captured fixed object. The feature information of the captured fixed object may be information including an image of the captured fixed object, feature points extracted from the image of the captured fixed object, and features of the captured fixed object such as an installation height of the captured fixed object. The feature information of the captured fixed object may be provided in the form of, for example, a segmentation image, a feature map, and/or a feature vector, but is not necessarily limited thereto.

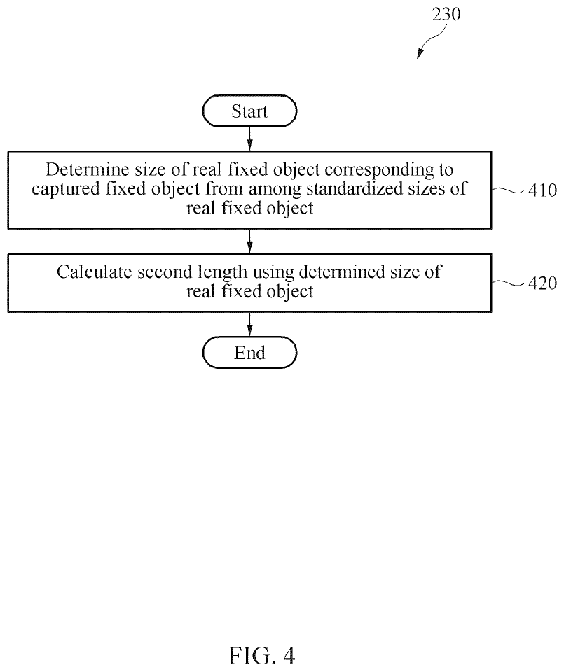

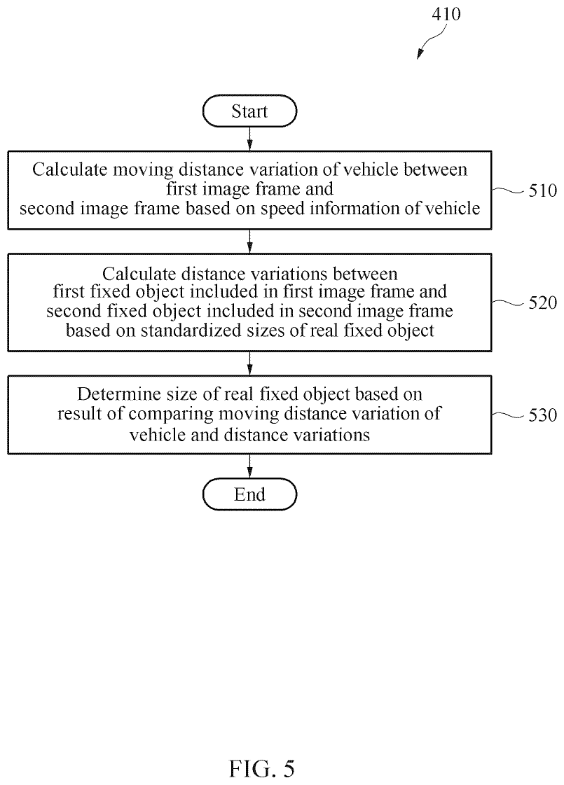

In operation 230, the estimation apparatus may calculate a second length of a real fixed object corresponding to the captured fixed object. An example method of estimating the second length by the estimation apparatus will be described in detail below with reference to FIGS. 4 and 5.

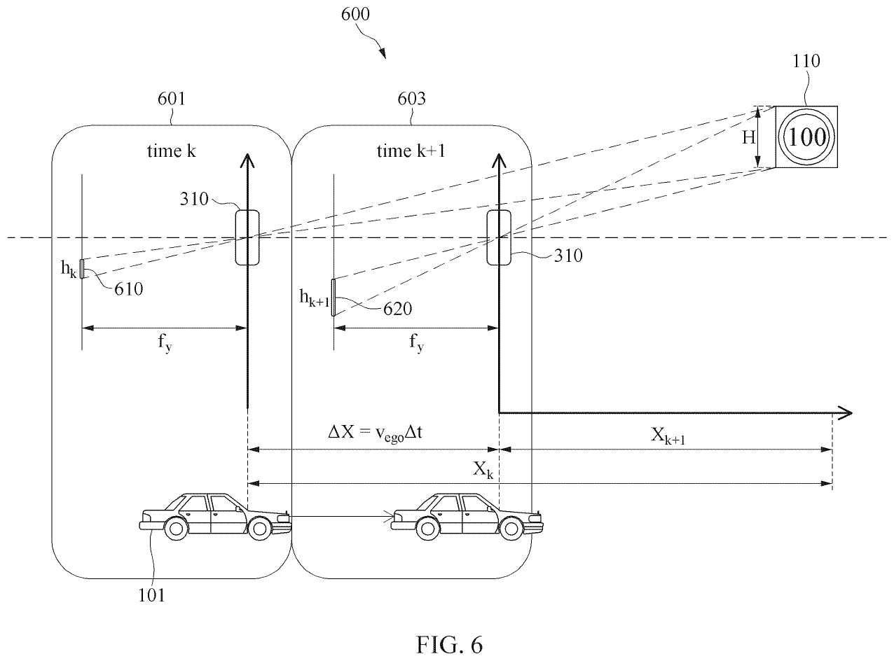

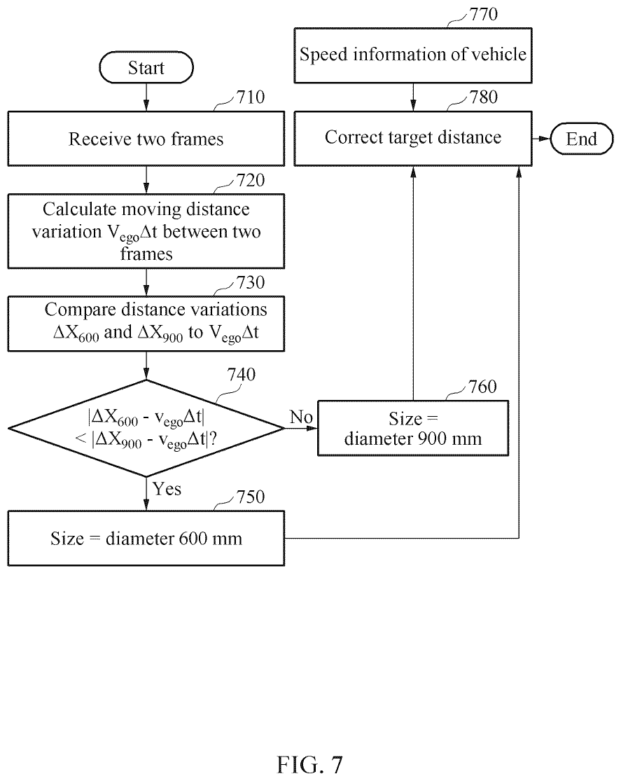

In operation 240, the estimation apparatus may estimate a target distance between the vehicle and the real fixed object based on a ratio between the first length calculated in operation 220 and the second length calculated in operation 230. An example method of estimating the target distance by the estimation apparatus will be described in detail below with reference to FIGS. 6 and 7. The estimation apparatus may then correct a position of the vehicle by mapping the estimated target distance to map information.

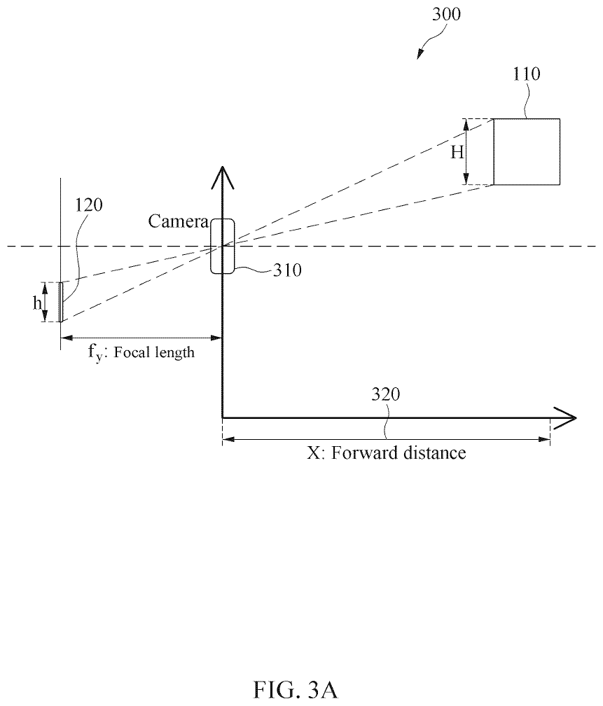

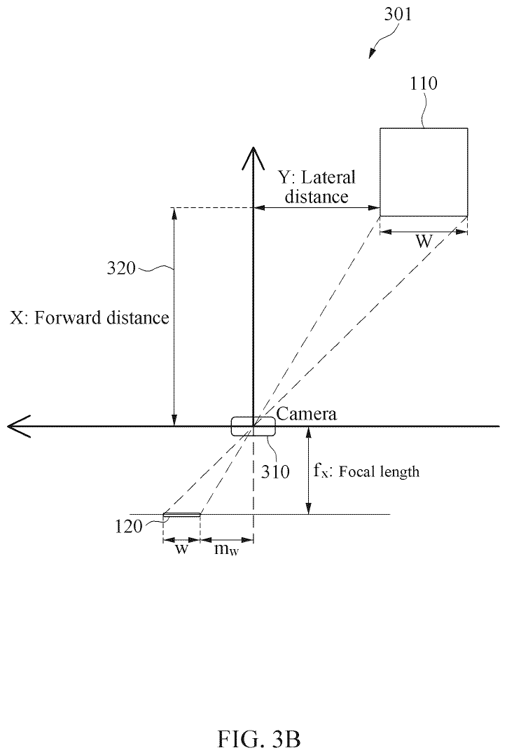

FIG. 3A illustrates an example method of estimating a target distance based on a height corresponding to a captured fixed object according to one or more example embodiments. Referring to FIG. 3A, diagram 300 illustrates a situation in which a real fixed object 110 is represented in a world domain and a captured fixed object 120, obtained by a single camera 310 capturing an image of the real fixed object 110, is represented in an image domain.

A relationship represented in Equation 1 below, for example, may be established between the captured fixed object 120 in the image domain and the real fixed object 110 in the world domain.

$$\begin{matrix}{f}_{y} : h = X : H \\ X = {f}_{y} \frac{H}{h}\end{matrix} \qquad Equation 1$$

In Equation 1, f_{y} denotes a focal length between the single camera 310 and the real fixed object 110. h denotes a vertical length of the captured fixed object 120 in the image domain. X denotes a forward distance from a vehicle in which the single camera 310 is installed to the real fixed object 110, that is, a target distance 320. H denotes a vertical length of the real fixed object 110 in the world domain. In this case, it may be assumed that the focal length f_{y} is known in advance.

Based on the vertical length H of the real fixed object 110, the estimation apparatus may calculate the target distance X 320 as expressed by Equation 1 above. For example, in the case of the real fixed object 110 being a speed sign, a standardized size of the real fixed object 110 may be any one of a diameter of 600 millimeters (mm) and a diameter of 900 mm. In addition, the vertical length h of the captured fixed object 120 may be determined using a neural network that is trained in advance to detect the captured fixed object 120 using a bounding box and calculate a first length of the captured fixed object 120 as described above with reference to FIG. 2.

Based on the focal length f_{y} and the first length h, the estimation apparatus may calculate the target distance X 320 by discriminating whether the size of the real fixed object 110 is 600 mm in diameter or 900 mm in diameter. An example method of calculating the target distance X 320 by the estimation apparatus will be described in detail below with reference to FIGS. 4 to 6.

FIG. 3B illustrates an example method of estimating a target distance based on a width corresponding to a captured fixed object according to one or more example embodiment. Referring to FIG. 3B, a top view 301 obtained by changing a side view of a pinhole model illustrated in FIG. 3A is illustrated. When the side view of FIG. 3A is changed to the top view 301 of FIG. 3B, Equation 1 described above may be expressed as a proportional equation as in Equation 2 below, for example. The estimation apparatus may calculate a lateral distance Y of a fixed object 110 through Equation 2.

$$\begin{matrix}{f}_{x} : {m}_{w} = X : Y \\ Y = X \frac{{m}_{w}}{{f}_{x}}\end{matrix} \qquad Equation 2$$

In Equation 2, fₓ denotes a focal length between a single camera 310 and the real fixed object 110 in the top view 301. w denotes a width of a captured fixed object 120 in an image domain. X denotes a target distance 320 from a vehicle in which the single camera 310 is installed to the real fixed object 110. m_{w} denotes a distance between the captured fixed object 120 in the image domain and an optical axis. W denotes a horizontal length (i.e., width) of the real fixed object 110 in a world domain.

By calculating the lateral distance Y of the fixed object 110 through Equation 2 described above, the estimation apparatus may determine an accurate position of the real fixed object 110 in a three-dimensional (3D) space and use the position of the real fixed object 110 for compensating for a position of the ego vehicle.

FIG. 4 illustrates an example method of calculating a second length according to one or more example embodiments. Operations to be described hereinafter may be performed in sequential order but not be necessarily performed in sequential order. For example, the order of the operations may be changed and at least two of the operations may be performed in parallel. Referring to FIG. 4, the estimation apparatus may calculate a second length through operations 410 and 420.

In operation 410, the estimation apparatus may determine a size of a real fixed object corresponding to a captured fixed object from among standardized sizes of the real fixed object. For example, as described above with reference to FIG. 3A or 3B, the estimation apparatus may determine at least one of a length or a width corresponding to the captured fixed object. The estimation apparatus may determine the size of the real fixed object corresponding to the captured fixed object, using at least one of the length and/or the width corresponding to the captured fixed object and speed information of a vehicle. An example method of determining the size of the real fixed object by the estimation apparatus will be described in detail below with reference to FIG. 5.

In operation 420, the estimation apparatus may calculate the second length using the size of the real fixed object determined in operation 410. The estimation apparatus may set a length (or height) component of the size of the real fixed object determined in operation 410 as the second length.

FIG. 5 illustrates an example method of determining a size of a real fixed object according to one or more example embodiments, and FIG. 6 illustrates an example method of estimating a target distance based on a moving distance variation of a vehicle between image frames and a distance variation between fixed objects included respectively in the image frames according to one or more example embodiments. Operations to be described hereinafter may be performed in sequential order but not be necessarily performed in sequential order. For example, the order of the operations may be changed and at least two of the operations may be performed in parallel.

Referring to FIGS. 5 and 6, the estimation apparatus may determine a size of a real fixed object 110 corresponding to a captured fixed object through operations 510 to 530 described below.

The estimation apparatus may detect the real fixed object 110 using a trained neural network, but, for example, in a case in which there are circular signs of the same shape but different sizes, for example, a 600 mm circular sign and a 900 mm circular sign, a typical estimation apparatus may not easily discriminate the 600 mm circular sign and the 900 mm circular sign. As illustrated in diagram 600 of FIG. 6, the estimation apparatus may verify whether a distance variation ΔX between two image frames 601 and 603 obtained by capturing a first fixed object (e.g., the 600 mm circular sign) 610 and a second fixed object (e.g., the 900 mm circular sign) 620, respectively, is the same as a moving distance variation V_{ego}Δt of a vehicle 101 obtained through a speedometer, and determine, as the size of the real fixed object 110, one circular sign with a smaller difference with the moving distance variation V_{ego}Δt.

For example, the image frames may include a first image frame 601 and a second image frame 603 each including a captured fixed object. In this example, the first image frame 601 may be an image frame obtained by capturing an image of the first fixed object (e.g., the 600 mm circular sign) 610 at time k. The second image frame 630 may be an image frame obtained by capturing an image of the second fixed object (e.g., the 900 mm circular sign) 620 at time k+1.

In operation 510, the estimation apparatus may determine a moving distance variation V_{ego}Δt of the vehicle 101 between the first image frame 601 and the second image frame 603 based on speed information of the vehicle 101.

In operation 520, the estimation apparatus may calculate distance variations between the first fixed object 610 included in the first image frame 601 and the second fixed object 620 included in the second image frame 603, based on each of the standardized sizes of the real fixed object 110. In this case, the standardized sizes of the real fixed object 110 may include, for example, a first size and a second size different from the first size. The estimation apparatus may calculate a first distance variation ΔX₆₀₀ between the first fixed object 610 and the second fixed object 620 based on the first size (e.g., 600 mm). When the size of the real fixed object 110 is set to the first size, the estimation apparatus may calculate the first distance variation ΔX₆₀₀ between the first fixed object 610 and the second fixed object 620.

The estimation apparatus may calculate a second distance variation ΔX₉₀₀ between the first fixed object 610 and the second fixed object 620 based on the second size (e.g., 900 mm). When the size of the real fixed object 110 is set to the second size, the estimation apparatus may calculate the second distance variation ΔX₉₀₀ between the first fixed object 610 and the second fixed object 620.

In operation 530, the estimation apparatus may determine the size of the real fixed object 110 based on a result of comparing the moving distance variation V_{ego}Δt of the vehicle 101 calculated in operation 510 and the distance variations ΔX₆₀₀ and ΔX₉₀₀ calculated in operation 520. The estimation apparatus may calculate a first difference |ΔX₆₀₀-V_{ego}Δt| between the moving distance variation V_{ego}Δt of the vehicle 101 and the first distance variation ΔX₆₀₀. The estimation apparatus may calculate a second difference |ΔX₉₀₀-V_{ego}Δt| between the moving distance variation V_{ego}Δt of the vehicle 101 and the second distance variation ΔX₉₀₀.

The estimation apparatus may determine the size of the real fixed object 110 corresponding to the captured fixed object based on a result of comparing the first difference and the second difference. For example, in response to the first difference being less than the second difference, the estimation apparatus may determine the first size (e.g., 600 mm) as the size of the real fixed object 110 corresponding to the captured fixed object. In response to the first difference being greater than or equal to the second difference, the estimation apparatus may determine the second size (e.g., 900 mm) as the size of the real fixed object 110 corresponding to the captured fixed object. The estimation apparatus may calculate a target distance between the vehicle 101 and the real fixed object 110 by obtaining a vertical length of the real fixed object 110 through the method described above.

FIG. 7 illustrates an example method of estimating a target distance according to one or more example embodiments. Referring to FIG. 7, the estimation apparatus may correct an estimated target distance through operations 710 to 780 described below.

In operation 710, the estimation apparatus may receive two frames (e.g., a first image frame and a second image frame). The first image frame and the second image frame may each include a captured fixed object.

In operation 720, the estimation apparatus may calculate a moving distance variation V_{ego}Δt of a vehicle based on speed information of the vehicle.

In operation 730, the estimation apparatus may compare distance variations between a first fixed object included in the first image frame and a second fixed object included in the second image frame to the moving distance variation V_{ego}Δt of the vehicle between the two frames. The estimation apparatus may calculate the distance variations between the first fixed object included in the first image frame and the second fixed object included in the second image frame, based on each of standardized sizes of a real fixed object. In this case, the standardized sizes of the real fixed object may include a first size (e.g., 600 mm) and a second size (e.g., 900 mm) different from the first size. The estimation apparatus may calculate a first distance variation ΔX₆₀₀ between the first fixed object and the second fixed object based on the first size. The estimation apparatus may calculate a second distance variation ΔX₉₀₀ between the first fixed object and the second fixed object based on the second size.

In operation 740, the estimation apparatus may compare the moving distance variation V_{ego}Δt of the vehicle calculated in operation 720 and the distance variations ΔX₆₀₀ and ΔX₉₀₀. The estimation apparatus may determine the size of the real fixed object based on a result of comparing the moving distance variation V_{ego}Δt and the distance variations ΔX₆₀₀ and ΔX₉₀₀.

The estimation apparatus may calculate a first difference (e.g., |ΔX₆₀₀-V_{ego}Δt|) between the moving distance variation of the vehicle and the first distance variation. The estimation apparatus may calculate a second difference (e.g., |ΔX₉₀₀-V_{ego}Δt|) between the moving distance variation of the vehicle and the second distance variation. The estimation apparatus may determine the size of the real fixed object corresponding to the captured fixed object based on a result of comparing the first difference and the second difference. For example, when it is determined in operation 740 that the first difference is less than the second difference, the estimation apparatus may determine the first size (e.g., 600 mm) as the size of the real fixed object in operation 750. When it is determined in operation 740 that the first difference is greater than or equal to the second difference, the estimation apparatus may determine the second size (e.g., 900 mm) as the size of the real fixed object in operation 760. The estimation apparatus may set the determined size as a length of the real fixed object and estimate a target distance based on Equation 1 above.

In operation 780, the estimation apparatus may correct the target distance using vehicle speed information 770 and a Kalman filter (or KF). The Kalman filter may refer to an optimal estimation technique for finding a state variable of a target system using a probabilistic model of the system and a measured value (e.g., the target distance). The Kalman filter may correspond to an algorithm that estimates a state value through time propagation by a state equation and improvement by a measurement equation and minimizes an error covariance between a real state value and the estimated state value. The Kalman filter may calculate a final estimated value by selecting a value with the highest probability as an estimated value based on a probability distribution of the estimated value and appropriately correcting a predicted value with a prediction error of a measured value. The Kalman filter may calculate a new estimated value by compensating for a difference between the measured value and the predicted value, after predicting what a state and an error covariance at a next time will be based on the system model. In this case, the new estimated value may be a final result from the Kalman filter. The new estimated value may be continuously updated through repetitions of the foregoing process.

For example, when the size of the real fixed object corresponding to the captured fixed object, i.e., the length of the real fixed object, is determined to be H, the estimation apparatus may correct the target distance through Equation 3 below, for example.

$$\begin{matrix}{x}_{k} = {F}_{k} {x}_{k - 1} + {u}_{k - 1} + {w}_{k - 1} \\ {z}_{k} = {H}_{k} {x}_{k} + {v}_{k}\end{matrix} \qquad Equation 3$$

In Equation 3, k denotes time. Xx denotes a state variable at time k. Fₖ denotes a transition matrix at the time k. Uₖ₋₁ denotes an input at time k-1. Wₖ₋₁ denotes process noise at the time k-1. Zₖ denotes a measurement (or measured value) at the time k. Hₖ denotes an observation matrix at the time k. Vₖ denotes measurement noise at the time k.

After estimating a distance to the real fixed object, the estimation apparatus may construct a one-dimensional Kalman filter for a target distance X as expressed by Equation 4 below, for example, for correction.

$$\begin{matrix}{x}_{k} = X \\ {z}_{k} = {f}_{y} \frac{H}{{h}_{k}} \\ {F}_{k} = {H}_{k} = 1\end{matrix} \qquad Equation 4$$

The prediction and update process of the Kalman filter may be expressed by Equation 5 below, for example.

$${\hat{x}}_{k \vert k - 1} = {F}_{k} {\hat{x}}_{k - 1 \vert k - 1} - {v}_{ego , k} Δ t \\ {P}_{k \vert k - 1} = {F}_{k} {P}_{k - 1 \vert k - 1} {F}_{k}^{T} + {Q}_{k} \\ {K}_{k} = {P}_{k \vert k - 1} {{H}_{k}^{T} ( {H}_{k} {P}_{k - 1 \vert k - 1} {H}_{k}^{T} + {R}_{k} )}^{- 1} \\ {\hat{x}}_{k \vert k} = {\hat{x}}_{k \vert k - 1} + {K}_{k} ( {z}_{k} - {H}_{k} {\hat{x}}_{k \vert k - 1} ) \\ {P}_{k \vert k} = ( I - {K}_{k} {H}_{k} ) {P}_{k \vert k - 1} \qquad Equation 5$$

In Equation 5, \hat{x} denotes a value predicted in the Kalman filter. k k-1 denotes a state at time k when information on time k-1 is given. P denotes a covariance of state variables. Q denotes a covariance of process noise. K denotes a Kalman gain.

The estimation apparatus may perform the prediction process using vehicle speed information V_{ego,k} as expressed by \hat{x}_{k|k-1}=Fₖ\hat{x}_{k-1|k-1}−V_{ego,k}Δt in Equation 5. The estimation apparatus may perform the update process by compensating for the target distance H to the real fixed object calculated as expressed by

$${z}_{k} = {f}_{y} \frac{H}{{h}_{k}}$$

in Equation 4 with a measured value. The estimation apparatus may more accurately correct the target distance through the foregoing process using the Kalman filter.

According to an example embodiment, when a width of the real fixed object corresponding to the captured fixed object is determined, the estimation apparatus may correct the target distance by using, as a measured value, a moving distance of the vehicle obtained from a speedometer.

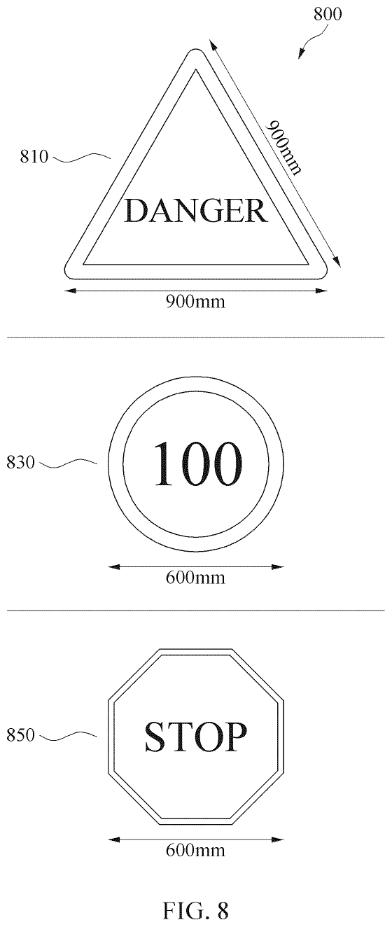

FIG. 8 illustrates examples of fixed objects according to one or more example embodiments. Referring to FIG. 8, diagram 800 illustrates example fixed objects having standardized shapes of different sizes. The fixed objects may have standardized shapes, for example, a triangular sign 810, a circular sign 830, and an octagonal sign 850 as shown in FIG. 8, but are not necessarily limited thereto. The fixed objects may include, for example, a speed sign, a distance sign, and a warning sign as shown in FIG. 8, or various structures having specific standards, such as, for example, a milestone, a historical site sign, a traffic light, or the like.

FIG. 9 illustrates an example apparatus for estimating a target distance (or an estimation apparatus herein) according to one or more example embodiments. Referring to FIG. 9, an estimation apparatus 900 may include a communication interface 910 and a processor 930 (e.g., one or more processors). The estimation apparatus 900 may further include an output device 950 and a memory 970 (e.g., one or more memories).

The communication interface 910 may receive an image frame including a fixed object of which an image is captured by a single camera. The single camera may be installed in a vehicle or may be a separate device.

The processor 930 may calculate a first length of the captured fixed object included in the image frame received through the communication interface 910. The processor 930 may calculate a second length of a real fixed object corresponding to the captured fixed object. The processor 930 may estimate a target distance between the vehicle and the real fixed object based on a ratio between the first length and the second length.

The output device 950 may output the target distance estimated by the processor 930. The output device 950 may be, for example, an output interface or a display device. For example, in the case of the output device 950 being a display, the output device 950 may display the target distance estimated by the processor 930 on an input image or a navigation image. Alternatively, when it is predicted that there is a need to change a driving lane or a lane based on the target distance estimated by the processor 930, the output device 950 may display a direction in which the driving lane needs to be changed.

The memory 970 may store the image frame received through the communication interface 910. The memory 970 may store the target distance between the vehicle and the real fixed object that is estimated by the processor 930 and/or a corrected target distance obtained through correction of the target distance.

The memory 970 may store standardized sizes of the real fixed object.

In addition, the memory 970 may store parameters of a neural network pretrained to calculate the first length based on a bounding box for detecting the captured fixed object. The processor 930 may calculate the first length using a neural network to which the parameters of the neural network stored in the memory 970 are applied. The neural network may be, for example, a CNN, but is not necessarily limited thereto. The CNN may be trained to determine both a bounding box of a fixed object to be detected in an input image and a type of the fixed object to be detected.

In addition, the memory 970 may store various information generated during a processing process of the processor 930. The memory 970 may also store various data and programs. The memory 970 may include a volatile memory or a non-volatile memory. The memory 970 may include a high-capacity storage medium such as a hard disk to store various data.

In addition, the processor 930 may perform methods described above with reference to FIGS. 1 to 8 or algorithms corresponding to the methods. The processor 930 may execute a program and control the estimation apparatus 900. A code of the program executed by the processor 930 may be stored in the memory 970. For example, the memory 970 may be or include a non-transitory computer-readable storage medium storing instructions that, when executed by the processor 930, configure the processor 930 to perform any one, combination, or all of the operations and methods described herein with reference to FIGS. 1-9.

The processor 930 may be, for example, a mobile application processor (AP), but is not necessarily limited thereto. Alternatively, the processor 930 may be a hardware-implemented image processing device having a physically structured circuit to perform desired operations. The desired operations may include, for example, codes or instructions included in a program. The estimation apparatus 900 (or a hardware-implemented estimation apparatus 900) may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

FIG. 10 illustrates an example vehicle according to one or more example embodiments. Referring to FIG. 10, a vehicle 1000 may include a single camera 1010 and a processor 1030 (e.g., one or more processors). The vehicle 1000 may further include a memory 1050 (e.g., one or more memories). The single camera 1010, the processor 1030, and the memory 1050 may communicate through a communication bus 1005.

The single camera 1010 may capture an image frame including a fixed object.

The processor 1030 may calculate a first length of a captured fixed object included in the image frame. The processor 1030 may calculate a second length of a real fixed object corresponding to the captured fixed object. The processor 1030 may estimate a target distance between the vehicle 1000 and the real fixed object based on a ratio between the first length and the second length. The processor 1030 may correct a position of the vehicle 1000 by mapping the target distance to map information. The map information may correspond to, for example, a high-definition (HD) map, which is a 3D stereoscopic map with centimeter (cm) level precision for autonomous driving, but is not necessarily limited thereto.

The memory 1050 may store the image frame captured by the single camera 1010. The memory 1050 may store the first length and the second length calculated by the processor 1030 and/or the target distance estimated by the processor 1030.

In addition, the memory 1050 may store at least one program and/or various information generated in a processing process of the processor 1030. The memory 1050 may also store various data and programs. The memory 1050 may include, for example, a volatile memory or a non-volatile memory. The memory 1050 may include a high-capacity storage medium such as a hard disk to store various data. For example, the memory 1050 may be or include a non-transitory computer-readable storage medium storing instructions that, when executed by the processor 1030, configure the processor 1030 to perform any one, combination, or all of the operations and methods described herein with reference to FIGS. 1-10.

In addition, the processor 1030 may perform one or more methods described above with reference to FIGS. 1 to 9 or techniques corresponding to the methods. The processor 1030 may be, for example, a mobile AP, but is not necessarily limited thereto. Alternatively, the processor 1030 may be a hardware-implemented processing device having a physically structured circuit to perform desired operations. The desired operations may include, for example, codes or instructions included in a program. The vehicle 1000 (or a hardware-implemented vehicle 1000) may include, for example, a microprocessor, a central processing unit (e.g., a CPU), a graphics processing unit (e.g., a GPU), a processor core, a multi-core processor, a multiprocessor, an ASIC, an FPGA, and an NPU.

The vehicles, single cameras, estimation apparatuses, communication interfaces, processors, output devices, memories, communication buses, vehicle 101, single camera 310, estimation apparatus 900, communication interface 910, processor 930, output device 950, memory 970, vehicle 1000, single camera 1010, processor 1030, memory 1050, communication bus 1005, and other apparatuses, devices, units, modules, and components disclosed and described herein with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
determining a first length of a captured object included in an image frame captured by a single camera;
determining a second length of a real object corresponding to the captured object; and
estimating a target distance between an apparatus and the real object based on a ratio between the first length and the second length.

2. The method of claim 1, wherein the determining of the second length comprises:
determining a size of the real object from among standardized sizes of the real object; and
determining the second length using the determined size.

3. The method of claim 2, wherein the determining of the size of the real object comprises determining either one or both of a length and a width corresponding to the captured object.

4. The method of claim 2, wherein the determining of the size of the real object comprises determining the size of the real object based on speed information of the apparatus.

5. The method of claim 2, wherein
the image frame comprises a first image frame and a second image frame each including the captured object, and
the determining of the size of the real object comprises:
determining a moving distance variation of the apparatus between the first image frame and the second image frame based on speed information of the apparatus;
determining distance variations between a first fixed object included in the first image frame and a second fixed object included in the second image frame, based on each of standardized sizes of the real object; and
determining the size of the real object based on a result of comparing the moving distance variation of the apparatus and the distance variations.

6. The method of claim 5, wherein
the standardized sizes of the real object comprise a first size and a second size different from the first size, and
the determining of the distance variations comprises:
determining a first distance variation between the first fixed object and the second fixed object based on the first size; and
determining a second distance variation between the first fixed object and the second fixed object based on the second size.

7. The method of claim 6, wherein the determining of the size of the real object comprises:
determining a first difference between the moving distance variation of the apparatus and the first distance variation;
determining a second difference between the moving distance variation of the apparatus and the second distance variation; and
determining the size of the real object based on a result of comparing the first difference and the second difference.

8. The method of claim 7, wherein the determining of the size of the real object based on the result of comparing the first difference and the second difference comprises:
in response to the first difference being less than the second difference, determining the first size as the size of the real object; and
in response to the first difference being greater than or equal to the second difference, determining the second size as the size of the real object.

9. The method of claim 1, wherein the determining of the first length comprises determining the first length based on a bounding box for detecting the captured object.

10. The method of claim 1, wherein
the captured object includes a road sign, and
the road sign includes any one or any combination of any two or more of a speed sign, a distance sign, and a milestone.

11. The method of claim 1, further comprising correcting the target distance using speed information of the apparatus and a Kalman filter.

12. The method of claim 1, wherein the single camera comprises a pinhole camera.

13. The method of claim 1, further comprising correcting a position of the apparatus by mapping the target distance to map information.

14. A non-transitory computer-readable storage medium storing instructions that, when executed by one or more processors, configure the one or more processors to perform the method of claim 1.

15. An apparatus comprising:
one or more processors configured to:
determine a first length of a captured object included in an image frame captured by a single camera;
determine a second length of a real object corresponding to the captured object; and
estimate a target distance between an apparatus and the real object based on a ratio between the first length and the second length.

16. The apparatus of claim 15, wherein, for the determining of the second length, the one or more processors are configured to:
determine a size of the real object from among standardized sizes of the real object; and
determine the second length using the determined size.

17. The apparatus of claim 16, wherein
the image frame includes a first image frame and a second image frame each including the captured object, and
for the determining of the size of the real object, the one or more processors are configured to:
determine a moving distance variation of the apparatus between the first image frame and the second image frame based on speed information of the apparatus;
determine distance variations between a first fixed object included in the first image frame and a second fixed object included in the second image frame based on each of the standardized sizes of the real object; and
determine the size of the real object based on a result of comparing the moving distance variation of the apparatus and the distance variations.

18. The apparatus of claim 17, wherein
the standardized sizes of the real object include a first size and a second size different from the first size, and
for the determining of the distance variations, the one or more processors are configured to:
determine a first distance variation between the first fixed object and the second fixed object based on the first size; and
determine a second distance variation between the first fixed object and the second fixed object based on the second size.

19. The apparatus of claim 18, wherein, for the determining of the size of the real object, the one or more processors are configured to:
determine a first difference between the moving distance variation of the apparatus and the first distance variation;
determine a second difference between the moving distance variation of the apparatus and the second distance variation; and
determine the size of the real object based on a result of comparing the first difference and the second difference.

20. A vehicle comprising:
a single camera configured to capture an image frame including a fixed object; and
one or more processors configured to:
determine a first length of the fixed object included in the image frame;
determine a second length of a real fixed object corresponding to the fixed object;
estimate a target distance between the vehicle and the real fixed object based on a ratio between the first length and the second length; and
correct a position of the vehicle by mapping the target distance to map information.
